(19) United States
(12) Patent Application Publication
(10) Pub. No.: US 2015/0158256 A1
(43) Pub. Date: Jun. 11, 2015

(54) METHOD OF MANUFACTURING DIAL KNOB FOR OPENING/CLOSING AIR VENT

(71) Applicants: HYUNDAI MOTOR COMPANY, Seoul (KR); KIA MOTORS CORP., Seoul (KR)

(72) Inventor: Byung Seok KONG, Gunpo-si (KR)

(73) Assignees: HYUNDAI MOTOR COMPANY, Seoul (KR); KIA MOTORS CORP., Seoul (KR)

(21) Appl. No.: 14/459,718

(22) Filed: Aug. 14, 2014

(30) Foreign Application Priority Data
Dec. 11, 2013 (KR) 10-2013-0154256

(51) Int. Cl. B29C 70/68; C25D 5/54; C25D 3/04

(52) U.S. Cl. CPC B29C 70/68; C25D 3/04; C25D 5/54; B29K 2069/00

(57) ABSTRACT

A method of manufacturing a dial knob for opening/closing an air vent may include integrally molding a knob body, a decoration member and a knob actuator using a single mold to produce a semi-finished product, and plating the decoration member with a metal to form a metal plating to produce a finished dial knob.

### CROSS REFERENCE TO RELATED APPLICATION

The present application claims priority of Korean Patent Application Number 10-2013-0154256, filed on Dec. 11, 2013, the entire contents of which application are incorporated herein for all purposes by this reference.

### BACKGROUND OF INVENTION

1. Field of Invention

The present invention relates to a method of manufacturing a dial knob for opening/closing an air vent, and more particularly, to a method of manufacturing a dial knob for opening/closing an air vent, wherein the number of manufacturing processes is reduced, thus improving productivity and achieving cost savings.

2. Description of Related Art

Typically, a vehicle interior such as a dashboard includes, as illustrated in FIG. 1, an air vent 1 for discharging cold air or warm air generated from an air conditioning device into the inside of a vehicle, and a dial knob 10 which is rotatably provided at the side of the air vent 1 so as to adjust the volume of air. The outer surface of such a dial knob 10 is metallically plated in order to increase aesthetic appeal. A conventional method of manufacturing a plated dial knob 10 is illustrated in FIG. 2.

Specifically, the conventional method of manufacturing the dial knob includes integrally molding a knob body 11 made of polycarbonate (PC) and a knob actuator 12 made of a thermoplastic elastomer (TPE) using a mold, thus manufacturing a semi-finished product 13; molding a decoration member 14 made of an acrylonitrile-butadiene-styrene (ABS) resin, which is to be assembled to the decoration member coupling part 13a of the semi-finished product 13; plating the surface of the decoration member 14 with metal to form a metal plating 15, thus manufacturing a plated decoration member 15; and assembling the plated decoration member 15 to the decoration member coupling part 13a of the semi-finished product 13, thus manufacturing a finished dial knob 10.

However, the conventional method as above is problematic because the integral molding step for manufacturing the semi-finished product 13 and the step of molding the decoration member 14 are separately performed, and the step of assembling the plated decoration member 15 to the semi-finished product 13 is separately implemented, and thereby the number of manufacturing processes is excessive, thus decreasing productivity and remarkably increasing the mold cost, undesirably resulting in higher production cost.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Accordingly, the present invention has been made keeping in mind the above problems encountered in the related art and/or other problems, and is directed to providing a method of manufacturing a dial knob for opening/closing an air vent, wherein the number of manufacturing processes necessary for manufacturing a finished dial knob may be significantly reduced, thus improving productivity, and in particular, the mold cost may be lowered, thus achieving cost savings.

Various aspects of the present invention provide a method of manufacturing a dial knob for opening/closing an air vent, including integrally molding a knob body, a decoration member and a knob actuator using a single mold, thereby producing a semi-finished product, and plating the decoration member with a metal to form a metal plating, thereby producing a finished dial knob. The semi-finished product may be manufactured by sequentially integrally molding the knob body, the decoration member and the knob actuator using the single mold.

The knob body may be molded using a material comprising polycarbonate (PC) and the knob body may include a shaft coupling part located at a middle portion thereof, an arc-shaped decoration member coupling part located outside the shaft coupling part, and an edge which forms an outer circumference of the decoration member coupling part. The decoration member may be integrally molded using a material comprising an acrylonitrile-butadiene-styrene (ABS) resin to be coupled to the decoration member coupling part, after the molding of the knob body. The knob actuator may be integrally molded using a material comprising a thermoplastic elastomer (TPE) to be coupled to the shaft coupling part and the edge, after the molding of the decoration member to the knob body.

The metal plating may be a chromium (Cr) plating. The knob actuator may be molded using styrene-ethylene-butadiene-styrene (SEBS)-based TPE including a mixture of a styrene-based thermoplastic elastomer and a polyolefin to prevent the knob actuator from being plated with Cr upon plating the decoration member with Cr.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

The above and other objects, features and advantages of the present invention will be more clearly understood from the following detailed description taken in conjunction with the accompanying drawings, in which:

FIG. 1 illustrates a dial knob provided at the side of an air vent;

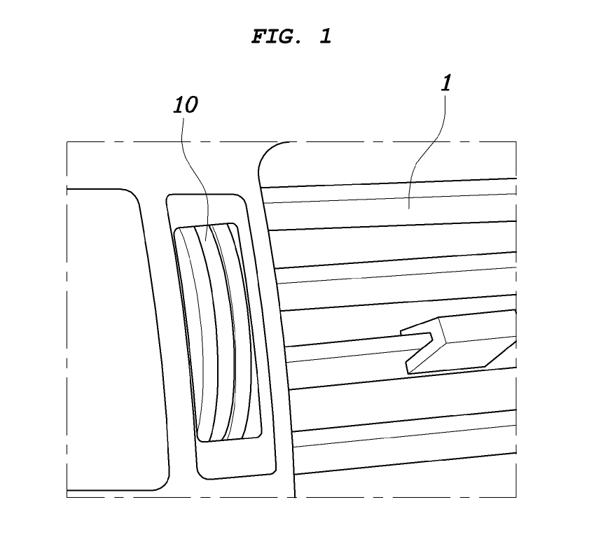

FIG. 2 illustrates a conventional process of manufacturing a dial knob;

FIG. 3 illustrates an exemplary process of manufacturing a dial knob for opening/closing an air vent according to the present invention; and

FIG. 4 illustrates a cross-sectional view of an exemplary dial knob manufactured by an exemplary manufacturing process according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

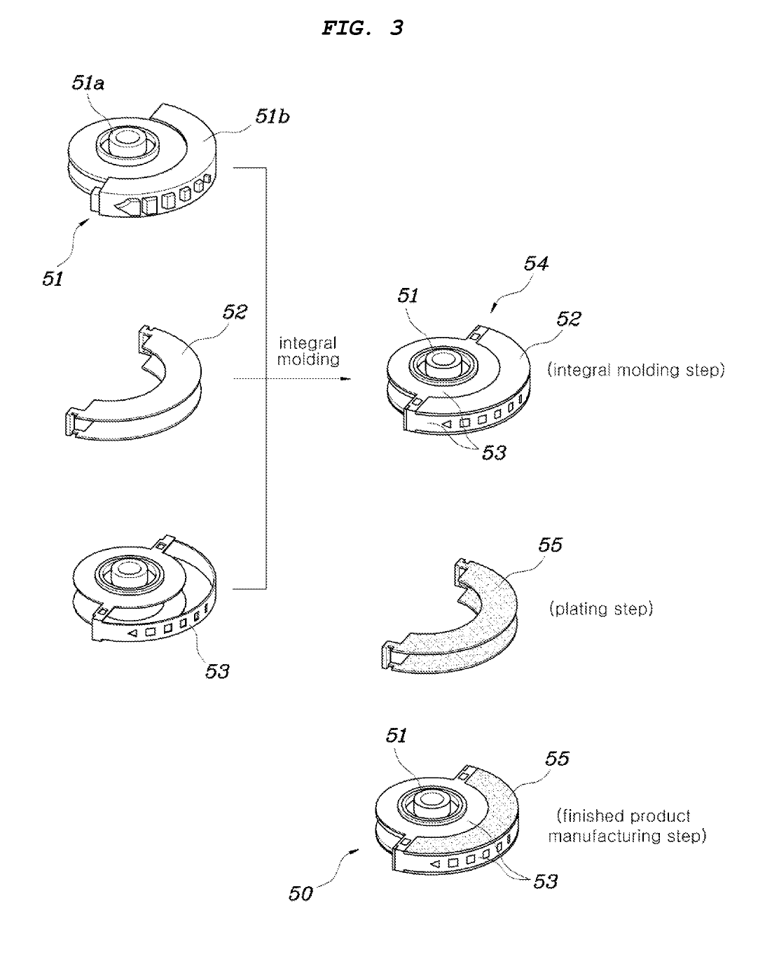

According to the present invention, the method of manufacturing a dial knob for opening/closing an air vent includes, as illustrated in FIG. 3, integrally or monolithically molding a knob body 51, a decoration member 52 and a knob actuator 53 using a single mold, thus manufacturing a semi-finished product 54; and plating the decoration member 52 with metal to form a metal plating 55, thereby obtaining a finished dial knob 50.

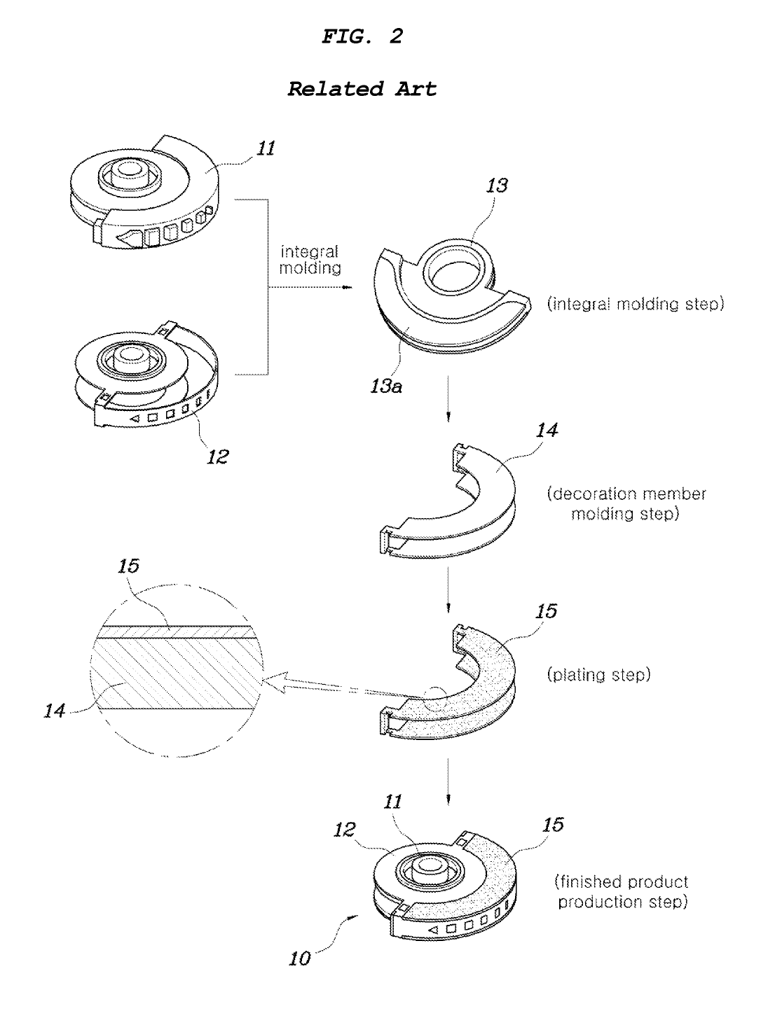

Specifically, the manufacturing method according to the present invention enables the semi-finished product 54 having the same shape as that of the finished dial knob to be integrally or monolithically molded using a single mold, and also the metal plating 55 to be finally formed, thereby completing the finished dial knob 50, ultimately significantly reducing the number of manufacturing processes compared to the conventional manufacturing method described with reference to FIG. 2.

The semi-finished product 54 according to the present invention is manufactured by sequentially integrally or monolithically molding the knob body 51, the decoration member 52 and the knob actuator 53 using a single mold, and thereby the number of manufacturing processes may be significantly reduced, ultimately improving productivity, especially reducing the mold cost to thus achieve cost savings.

The knob body 51 is molded using, for example, PC (Polycarbonate) or a material comprising PC so as to include a shaft coupling part 51a located at the middle portion thereof; an arc-shaped decoration member coupling part 51b located outside the shaft coupling part 51a; and an edge 51c which forms the outer circumference of the decoration member coupling part 51b.

After molding of the knob body 51, the decoration member 52 is integrally or monolithically molded using, for example, ABS (Acrylonitrile-butadiene-styrene) resin or a material comprising ABS resin so as to be coupled to the decoration member coupling part 51b of the knob body 51.

After molding of the decoration member 52 to the knob body 51, the knob actuator 53 is integrally or monolithically molded using, for example, TPE (Thermoplastic elastomer) or a material comprising TPE so as to be coupled to the shaft coupling part 51a and the edge 51c of the knob body 51, thereby completing the fabrication of a dial knob in the form of the semi-finished product 54.

The metal plating 55 formed on the decoration member 52 is a Cr plating, but may be an ion plating or a different type of plating with metal texture. The Cr plating is intended to increase aesthetic appeal of a product to thus achieve high quality. For cost savings, in some embodiments, only the decoration member 52 which is exposed to the inside of a vehicle is preferably plated, except for the knob actuator 53.

The Cr plating is formed by etching the surface of a plating target using chromic acid, attaching palladium (Pd) to the etched portion to form a metal film, imparting the metal film with conductivity, and then plating it with Cr.

In various embodiments of the present invention, because the knob body 51 made of PC is difficult for etching using chromic acid, a metal plating 55 using Cr is not formed on the knob body 51.

In some embodiments of the present invention, the knob actuator 53 is molded using TPE. Because typical TPE may efficiently undergo etching using chromic acid, when the knob actuator 53 is molded using typical TPE, the knob actuator 53 may be partially plated in the subsequent Cr plating process.

To improve quality of the products such that the Cr plating is formed only on the decoration member 52 while preventing the knob actuator 53 from being plated with Cr upon plating the decoration member 52 with Cr, in various embodiments of the present invention, the knob actuator 53 is preferably molded using, for example, SEBS (Styrene-ethylene-butadiene-styrene)-based TPE composed of a mixture of a styrene-based thermoplastic elastomer and a polyolefin, or the like.

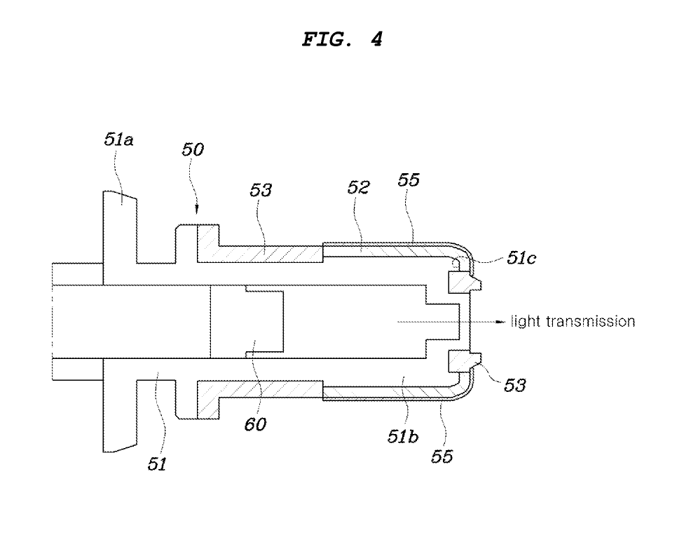

FIG. 4 illustrates a cross-sectional view of the dial knob 50 manufactured by the method according to the present invention. As illustrated in FIG. 4, the decoration member 52 and the knob actuator 53 are integrally or monolithically molded at the same or substantially the same thickness to the knob body 51, and the metal plating 55 is formed on the surface of the decoration member 52. Because the boundary portion between the decoration member 52 and the knob actuator 53 may be covered with the metal plating 55, the outer appearance may be further improved.

Also, a light source 60 is provided in the knob body 51 so that light of the light source 60 is irradiated through the knob actuator 53, thus improving ease of use through lighting and achieving high quality.

In various embodiments of the present invention as above, the knob body 51, the decoration member 52 and the knob actuator 53 are integrally or monolithically molded using a single mold, after which the decoration member 52 is plated with metal to form the metal plating 55, thereby manufacturing a finished dial knob 50. Therefore, the number of manufacturing processes may be significantly reduced, compared to a conventional method of manufacturing a finished dial knob 10 by integrally molding a knob body and a knob actuator using a mold, molding a decoration member using another mold, plating the decoration member with metal to form a metal plating, and assembling the decoration member having the metal plating to the knob body integrally molded with the knob actuator.

Also, as the number of manufacturing processes is reduced in the present invention, productivity may be improved, and in particular, cost savings may be achieved through reduction of the mold cost.

As described hereinbefore, the present invention provides a method of manufacturing a dial knob for opening/closing an air vent. According to the present invention, a finished dial knob can be manufactured by integrally or monolithically molding a knob body, a decoration member and a knob actuator using a single mold and then plating the decoration member with metal to form a metal plating. Therefore, as the number of manufacturing processes necessary for manufacturing the dial knob for opening/closing an air vent can be significantly reduced, productivity can be improved, and in particular, the mold cost can be decreased to thus achieve cost savings.

For convenience in explanation and accurate definition in the appended claims, the terms “inner” or “outer”, “inside” or “outside”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method of manufacturing a dial knob for opening/closing an air vent, comprising:
integrally molding a knob body, a decoration member and a knob actuator using a single mold, thereby producing a semi-finished product; and
plating the decoration member with a metal to form a metal plating, thereby producing a finished dial knob.

2. The method of claim 1, wherein the semi-finished product is manufactured by sequentially integrally molding the knob body, the decoration member and the knob actuator using the single mold.

3. The method of claim 1, wherein the knob body is molded using a material comprising polycarbonate (PC) and the knob body includes:
a shaft coupling part located at a middle portion thereof;
an arc-shaped decoration member coupling part located outside the shaft coupling part; and
an edge which forms an outer circumference of the decoration member coupling part.

4. The method of claim 3, wherein the decoration member is integrally molded using a material comprising an acrylonitrile-butadiene-styrene (ABS) resin to be coupled to the decoration member coupling part, after the molding of the knob body.

5. The method of claim 3, wherein the knob actuator is integrally molded using a material comprising a thermoplastic elastomer (TPE) to be coupled to the shaft coupling part and the edge, after the molding of the decoration member to the knob body.

6. The method of claim 5, wherein the metal plating is a chromium (Cr) plating.

7. The method of claim 6, wherein the knob actuator is molded using styrene-ethylene-butadiene-styrene (SEBS)-based TPE comprising a mixture of a styrene-based thermoplastic elastomer and a polyolefin to prevent the knob actuator from being plated with Cr upon plating the decoration member with Cr.
